(19) United States
(12) Patent Application Publication
(10) Pub. No.: US 2011/0036615 A1
(43) Pub. Date: Feb. 17, 2011

(54) FLEXIBLE FLAT CIRCUITRY

(75) Inventors: Atsuhito Noda, Fujisawa-shi (JP); Toshihiro Niitsu, Machida-shi (JP)

Correspondence Address: MOLEX INCORPORATED, 2222 WELLINGTON COURT, LISLE, IL, 60532, US

(73) Assignee: Molex Incorporated, Lisle, IL (US)

(21) Appl. No.: 11/720,714

(22) PCT Filed: Dec. 1, 2005
(86) PCT No.: PCT/US2005/043354

§ 371 Date: Aug. 5, 2009

Related U.S. Application Data
(60) Provisional application No. 60/632,215, filed on Dec. 1, 2004.

(51) Int. Cl. H01B 7/08

(52) U.S. Cl. 174/117 F

(57) ABSTRACT

A transmission line is made from FFC and has an elongated support base with opposing top and bottom sides. The support base has a plurality of conductive traces arranged on both of its side with the traces on one of the support base sides being arranged in pairs of signal traces, and specifically pairs of differential signal traces. The traces which are arranged on the other side of the support base include ground traces, each of which preferably has a width that is greater than the combined width of two signal traces that make up a signal pair. Each of the ground traces are aligned with a pair of signal traces.

### BACKGROUND OF THE INVENTION

The present invention is directed generally to conductive transmission lines, and more particularly, flexible transmission lines utilizing flexible flat circuitry (“FFC”)for use in quickly transmitting signals between electronic devices.

One way to transfer signals between electronic devices is to use flat cable that may be twisted and flexed. This type of cable is known as either FFC or flexible flat cable. It is known, as demonstrated, by U.S. Pat. No. 4,798,918, issued Jan. 17, 1989, that one can arrange signal and ground traces in certain patterns to minimize cross talk between adjacent and opposing signal traces. This patent shows individual signal traces flanked by ground traces on each side and by a pair of ground traces on the opposite side of the FFC. It is difficult to maintain a constant impedance and high signal transfer speeds in certain transmission lines. When flexible printed circuitry (“FPC”) is used, there is a high signal attenuation. The multiple layer construction shown in the aforementioned '918 patent may increase the cost of the transmission line. The spacing of the ground and signal traces also becomes critical in controlling the impedance of the transmission line. The present invention is directed to a power contact that overcomes the aforementioned disadvantages.

### SUMMARY OF THE INVENTION

It is therefore an object of the present invention to provide an improved low impedance, flexible transmission line for use in connecting two electronic devices together. Another object of the present invention is to provide a flexible flat circuitry extent having a pattern of signal and ground traces arranged on opposing sides of a substrate that promotes the transmission of differential signals through transmission line.

Still another object of the present invention is to provide a FFC transmission line which includes an insulating substrate as a base layer for the transmission line and which includes a plurality of signal traces arranged on a first surface of the substrate and at least one ground trace disposed on a second surface of the substrate.

Yet a further object of the present invention is to provide a FFC transmission line for use in transmitting differential signals, and which uses a pair of signal traces disposed on one side of a support base and a wide ground trace disposed on the other side of the support base.

Still yet another object of the present invention is to provide a FFC transmission line for use in transmitting differential signals, and which uses a pair of differential signal traces disposed on one side of a support base and a wide ground trace associated with the differential signal pair disposed on the other side of the support base, the two signal traces being spaced apart a first given length and the ground trace having a width sufficient to permit it to extend on the other side of the support base with one edge of the ground trace being aligned with at least a longitudinal center line of the first signal trace and a second edge of the ground trace being aligned with at least a longitudinal center line of the second signal trace, such that when viewed from an end thereof, the ground trace overlaps the first and second signal traces.

The present invention provides these and other objects by way of its structure, which is briefly described below and is described in greater detail in the detailed description and drawings to follow.

In one aspect of the present invention, an improved signal transmission line is provided that has a FFC basis and which utilizes an elongated support base having opposing top and bottom sides. The support base has a plurality of conductive traces arranged on both of its top and bottom sides, and in one embodiment of the invention, the traces arranged on one of the support base sides include a plurality of traces that are arranged in signal pairs, specifically differential signal pairs. The traces that are arranged on the other side of the support base include ground traces, each of which preferably has a width that is greater than the combined width of two signal traces that make up a signal pair.

The ground traces are aligned with the signal traces (on opposite sides of the support base) so that portions of the signal traces overlap edges of the ground traces or vice-versa. In this manner, the wide ground traces are associated with substantially only their particular pair of differential signal traces. The ground traces are space wider apart from each other than the traces of each differential signal pair, but are more narrowly spaced apart from each other than the spacing between adjacent differential signal pairs. In this manner, impedances of between 90 and 110 ohms can be reliably achieved.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a end sectional view of an FFC transmission line constructed in accordance with the principles of the present invention;

FIG. 2 is a perspective view of another embodiment of an FFC transmission line constructed in accordance with the principles of the present invention;

FIG. 3 is a diagrammatic end view of the FFC transmission line of FIG. 1, illustrating the different ground trace widths which may be used in the present invention; and,

FIG. 4 is a perspective end view of another embodiment of a FFC transmission line of the present invention, illustrating a termination end portion thereof.

### DETAILED DESCRIPTION OF THE PREFERRED EMBODIMENTS

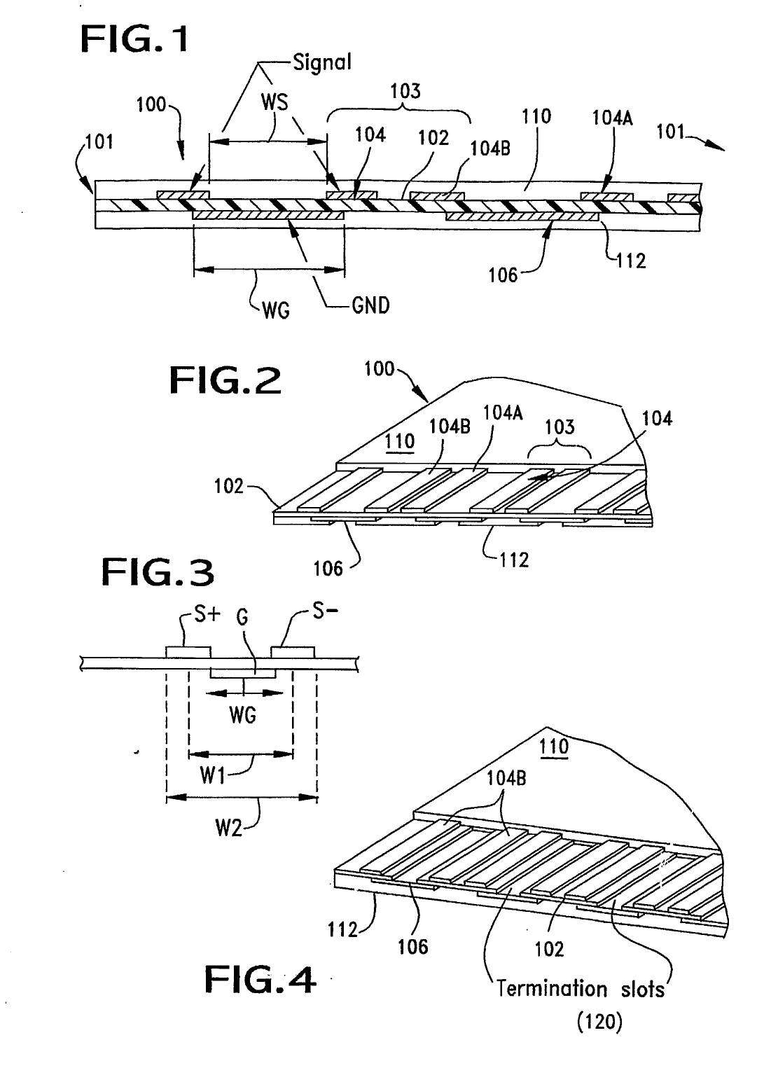

FIG. 1 illustrates an end view of an extent of FFC that incorporates the transmission lines of the present invention. The transmission line 100 is seen to have a support base, or substrate 102 that has a longitudinal extent between two opposing ends of the FFC and which has two side edges 101. This support base is formed of an insulative material.

The support base supports a plurality of conductive traces on opposing or top and bottom, as shown, surfaces. The bottom surface is seen in FIG. 1 to support a pair of ground traces, while the upper surface is seen to support five signal traces 104. The signal traces are arranged in pairs of traces, with each pair including traces 104A and 104B, with the pair of signal traces carrying differential signals from a source to a destination.

The two signal traces 104A, 104B of each pair of signal traces are spaced apart by a preselected distance WS. An associated ground trace 106, or “GND” is disposed on the opposite side of the substrate and is aligned with the pair of signal traces. As shown in FIG. 1, this alignment has the side edges of the ground trace 106 aligned with the longitudinal centerlines of its two differential signal traces. This is shown best in FIG. 3 diagrammatically with the width of the ground trace first being shown as WG, which is a width that is equal to the spacing between the interior side edges of the two differential signal traces. In these arrangements, the traces of each differential signal pair are arranged in a triad or triangular fashion, wherein the centers of the two signal traces and the associated ground trace are arranged at apices of an imaginary triangle.

The second width shown in FIG. 3, W1 is the width of a ground trace which is aligned with the centerlines of its associated signal traces. The third width that the ground traces of the present invention may take is shown as W2 in FIG. 3, where the edges of the ground trace will be aligned with the outer side edges of the differential signal trace pair. The importance of the width of the ground trace is as follows: as the width of the ground trace increases, so does the capacitance of the differential signal pair system (meaning each transmission line comprising two differential signal traces and an associated ground traces), and as the capacitance increases, the impedance of the system will decrease.

Conversely, as the width of the ground trace decreases, the capacitance will decrease and so increase the impedance of the differential signal pair system. Thus, the width of the ground trace may be tailored to increase or decrease the impedance of the differential signal system, i.e., the overall transmission lines of the FFC. With this structure, it is possible to achieve reliable transmission line impedances of about 90 to 110 ohms.

FIG. 4 is a perspective view of a termination end portion of a transmission line of the present invention in which the substrate layer 102 is slotted as at 120, or selectively removed so that conductive surfaces of the ground traces 106 are exposed for contact by connector terminals or the like.

The manufacturing cost for FFC of the present invention is lower than known FFC constructions in that it uses a simple structure with a dielectric tape as the substrate or support base. The support tape will preferably be PE, a polyimide or an FR-4 material, while the traces will be pure copper or tough-pitch cooper.

1. A transmission line of flexible flat circuitry, comprising:
an elongated support substrate having first and second opposing surfaces; and,
a plurality of conductive traces disposed on the opposing first and second surfaces defining at least one signal transmission line along said substrate, the traces being disposed in a pattern of pairs of signal traces on one side of substrate and at least one ground trace associated with one pair of signal traces, the ground trace having a width that is greater than the combined width of the associated one pair of signal traces.

2. The transmission line of claim 1, wherein each signal trace has a longitudinal centerline, and each ground trace has a pair of longitudinally extending side edges, the side edges of one ground traces being aligned with the centerlines of said differential signal traces.

3. The transmission line of claim 1, wherein each signal trace has a pair of longitudinal side edges and each ground trace has a pair of longitudinally extending side edges, the side edges of one ground traces being aligned with the outside side edges of said pair of differential signal traces.
